(19) United States
(12) Patent Application Publication
(10) Pub. No.: US 2026/0351870 A1
(43) Pub. Date: Nov. 5, 2026

(54) Terminal and Its Manufacturing Method, Electrical Connection Assembly and Electrical Connection Device

(71) Applicants: Tyco Electronics (Suzhou) Ltd., Suzhou City, Jiangsu Province (CN); Tyco Electronics (Shanghai) Co., Ltd., Shanghai (CN); TE Connectivity (Nantong) Co., Ltd., Nantong (CN)

(72) Inventors: Minjie ZHU, Suzhou (CN); Jingjing GU, Suzhou (CN); Lei PAN, Shanghai (CN); Daiqiong ZHANG, Shanghai (CN); Wei HE, Shanghai (CN)

(73) Assignees: Tyco Electronics (Suzhou) Ltd., Suzhou City, Jiangsu Province (CN); Tyco Electronics (Shanghai) Co., Ltd., Shanghai (CN); TE Connectivity (Nantong) Co., Ltd., Nantong (CN)

(21) Appl. No.: 19/660,300

(22) Filed: Apr. 28, 2026

(30) Foreign Application Priority Data
Apr. 30, 2025 (CN) 202510575177.2

(51) Int. Cl. H01R 4/62; H01R 4/02; H01R 4/18; H01R 13/10; H01R 43/16

(52) U.S. Cl. CPC H01R 4/62; H01R 4/023; H01R 4/184; H01R 13/10; H01R 43/16

(57) ABSTRACT

A terminal includes: an electrical contact part which is used to make electrical contact with a mating terminal; and an electrical connection part which is used for electrical connection with an aluminum cable. The electrical contact part and the electrical connection part are connected as a whole, the electrical contact part is a copper component or a copper alloy component, and the electrical connection part is an aluminum component or an aluminum alloy component. The electrical contact part may be made of copper or copper alloy and an electrical connection part made of aluminum or aluminum alloy. The copper or copper alloy electrical contact part can reliably and stably make electrical contact with a mating terminal, while the aluminum or aluminum alloy electrical connection part can reliably and stably connect with an aluminum cable, effectively avoiding electrochemical corrosion problem between the copper terminal and the aluminum cable.

### CROSS-REFERENCE TO RELATED APPLICATION

This application claims the benefit of Chinese Patent Application No. CN202510575177.2 filed on Apr. 30, 2025 in the State Intellectual Property Office of China, the whole disclosure of which is incorporated herein by reference.

### FIELD OF THE INVENTION

The present invention relates to a terminal and its manufacturing method. In addition, the present invention also relates to an electrical connection assembly comprising the terminal, and an electrical connection device comprising the terminal.

### BACKGROUND OF THE INVENTION

In the prior art, in order to improve the charging speed of new energy vehicles, the charging current needs to be increased to over 600A, and may even reach 1000A in the future. In order to improve the current carrying capacity of copper cables and reduce their heat generation, it is necessary to increase the cross-sectional size of copper cables, which will lead to a sharp increase in costs. In order to reduce costs, aluminum cables are used instead of traditional copper cables in the prior art. However, there are some technical issues that are difficult to overcome in the electrical connection between aluminum cables and copper terminals, such as electrochemical corrosion between copper and aluminum materials.

### SUMMARY OF THE INVENTION

The present invention has been made to overcome or alleviate at least one aspect of the above mentioned disadvantages.

According to an aspect of the present invention, there is provided a terminal. The terminal comprises: an electrical contact part which is used to make electrical contact with a mating terminal; and an electrical connection part which is used for electrical connection with an aluminum cable. The electrical contact part and the electrical connection part are connected as a whole, the electrical contact part is a copper component or a copper alloy component, and the electrical connection part is an aluminum component or an aluminum alloy component.

According to an exemplary embodiment of the present invention, the electrical contact part has at least one elastic arm for electrical contact with the mating terminal.

According to another exemplary embodiment of the present invention, the electrical contact part has at least one pair of elastic arms, each pair of elastic arms is used to clamp the mating terminal inserted between them for electrical contact with the mating terminal.

According to another exemplary embodiment of the present invention, the electrical contact part comprises a peripheral wall enclosing an insertion cavity, and an elastic arm is formed on the peripheral wall for electrical contact with a mating terminal inserted into the insertion cavity.

According to another exemplary embodiment of the present invention, the electrical contact part is cylindrical or tongue shaped and suitable for insertion into a female mating terminal to make electrical contact with the contact spring of the mating terminal.

According to another exemplary embodiment of the present invention, the electrical contact part of the terminal is an integral stamped part; and/or the electrical connection part of the terminal is an integral stamped part.

According to another exemplary embodiment of the present invention, the electrical connection part of the terminal is suitable for being welded to the connection end of the aluminum cable.

According to another exemplary embodiment of the present invention, the electrical connection part of the terminal has a flat welding part, which is suitable for being welded to the connection end of the aluminum cable.

According to another exemplary embodiment of the present invention, the electrical connection part of the terminal is suitable for being crimped onto the connection end of the aluminum cable.

According to another exemplary embodiment of the present invention, the electrical connection part of the terminal has a U-shaped crimping part, which is suitable for being crimped onto the connection end of the aluminum cable.

According to another exemplary embodiment of the present invention, the U-shaped crimping part comprises a pair of first crimping wings for crimping onto the connection end of the aluminum cable.

According to another exemplary embodiment of the present invention, the U-shaped crimping part further comprises a pair of second crimping wings for crimping onto the outer insulation layer of the aluminum cable.

According to another exemplary embodiment of the present invention, the electrical connection part of the terminal is suitable for being welded, crimped, hot-melt, riveted or bolted to the connection end of the aluminum cable.

According to another exemplary embodiment of the present invention, the electrical contact part is welded, hot melted, cold-rolled, riveted, crimped or bolted to the electrical connection part to connect the electrical contact part and the electrical connection part as a whole.

According to another exemplary embodiment of the present invention, the electrical contact part has a U-shaped rear end, and the electrical connection part has a U-shaped front end; the U-shaped rear end of the electrical contact part is welded or thermally fused to the U-shaped front end of the electrical connection part to connect the electrical contact part and the electrical connection part as a whole.

According to another exemplary embodiment of the present invention, a first saw tooth is formed on the electrical contact part, and a second saw tooth is formed on the electrical connection part; the first saw tooth meshes with the second saw tooth and they are welded, hot-melt welded, or cold-rolled together to connect the electrical contact part and the electrical connection part as a whole.

According to another aspect of the present invention, there is provided an electrical connection assembly. The electrical connection assembly comprises: the above terminal; and an aluminum cable which is electrically connected to the electrical connection part of the terminal.

According to another aspect of the present invention, there is provided an electrical connection device. The electrical connection device comprises: an insulation housing; the above terminal inserted into the insulation housing; and an aluminum cable which is electrically connected to the electrical connection part of the terminal and led out from the insulation housing.

According to an exemplary embodiment of the present invention, the electrical connection device is a connector, a charging dock, or a charging gun, and the terminal is a power terminal used for transmitting charging current.

According to another aspect of the present invention, there is provided a terminal manufacturing method, comprising the following steps of: providing a first metal plate and a second metal plate; connecting one side of the first metal plate and one side of the second metal plate together to form a metal sheet; stamping the metal sheet to form a terminal strip; and cutting the terminal strip to obtain multiple terminals. The first metal plate is a copper plate or a copper alloy plate, and an electrical contact part of the terminal for electrical contact with a mating terminal is made of the first metal plate, the second metal plate is an aluminum plate, and an electrical connection part of the terminal for electrical connection with an aluminum cable is made of the second metal plate.

According to an exemplary embodiment of the present invention, the terminal strip has a carrier part connected to the electrical connection part of the terminal for positioning and conveying the terminal, and the carrier part is made of the second metal plate.

According to another exemplary embodiment of the present invention, one side of the first metal plate and one side of the second metal plate are welded, hot-melt or cold-rolled together.

According to another exemplary embodiment of the present invention, a first saw tooth is formed on one side of the first metal plate, and a second saw tooth is formed on one side of the second metal plate; the first saw tooth meshes with the second saw tooth and they are welded, hot-melt welded, or cold-rolled together.

In the aforementioned exemplary embodiments according to the present invention, the terminal comprises an electrical contact part made of copper or copper alloy and an electrical connection part made of aluminum or aluminum alloy. Copper or copper alloy electrical contact part can reliably and stably make electrical contact with the mating terminal, while aluminum or aluminum alloy electrical connection part can reliably and stably connect with an aluminum cable, effectively avoiding electrochemical corrosion problem between the copper terminal and the aluminum cable.

### BRIEF DESCRIPTION OF THE DRAWINGS

The above and other features of the present invention will become more apparent by describing in detail exemplary embodiments thereof with reference to the accompanying drawings, in which:

FIG. 1 shows an illustrative perspective view of a terminal according to an exemplary first embodiment of the present invention;

FIG. 2 shows an illustrative exploded view of a terminal according to an exemplary first embodiment of the present invention;

FIG. 3 shows an illustrative perspective view of a terminal according to an exemplary second embodiment of the present invention;

FIG. 4 shows an illustrative exploded view of a terminal according to an exemplary second embodiment of the present invention;

FIG. 5 shows an illustrative perspective view of a terminal according to an exemplary third embodiment of the present invention;

FIG. 6 shows an illustrative exploded view of a terminal according to an exemplary third embodiment of the present invention;

FIG. 7 shows an illustrative perspective view of a terminal according to an exemplary fourth embodiment of the present invention;

FIG. 8 shows an illustrative exploded view of a terminal according to an exemplary fourth embodiment of the present invention;

FIG. 9 shows an illustrative perspective view of an exemplary first metal plate and second metal plate according to the present invention;

FIG. 10 shows an illustrative view of connecting the first metal plate and the second metal plate shown in FIG. 9 together;

FIG. 11 shows an illustrative perspective view of another exemplary first metal plate and second metal plate according to the present invention;

FIG. 12 shows an illustrative view of connecting the first metal plate and the second metal plate shown in FIG. 11 together;

FIG. 13 shows an illustrative view of a terminal strip made by stamping the metal sheet shown in FIGS. 10 or 12; and

FIG. 14 shows another illustrative view of a terminal strip made by stamping the metal sheet shown in FIGS. 10 or 12.

### DETAILED DESCRIPTION OF THE IVENTION

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to a general concept of the present invention, there is provided a terminal. The terminal comprises: an electrical contact part which is used to make electrical contact with a mating terminal; and an electrical connection part which is used for electrical connection with an aluminum cable. The electrical contact part and the electrical connection part are connected as a whole, the electrical contact part is a copper component or a copper alloy component, and the electrical connection part is an aluminum component or an aluminum alloy component.

According to another general concept of the present invention, there is provided an electrical connection assembly. The electrical connection assembly comprises: the above terminal; and an aluminum cable which is electrically connected to the electrical connection part of the terminal.

According to another general concept of the present invention, there is provided an electrical connection device. The electrical connection device comprises: an insulation housing; the above terminal inserted into the insulation housing; and an aluminum cable which is electrically connected to the electrical connection part of the terminal and led out from the insulation housing.

According to another general concept of the present invention, there is provided a terminal manufacturing method, comprising the following steps of: providing a first metal plate and a second metal plate; connecting one side of the first metal plate and one side of the second metal plate together to form a metal sheet; stamping the metal sheet to form a terminal strip; and cutting the terminal strip to obtain multiple terminals. The first metal plate is a copper plate or a copper alloy plate, and an electrical contact part of the terminal for electrical contact with a mating terminal is made of the first metal plate, the second metal plate is an aluminum plate, and an electrical connection part of the terminal for electrical connection with an aluminum cable is made of the second metal plate.

### First Illustrative Embodiment

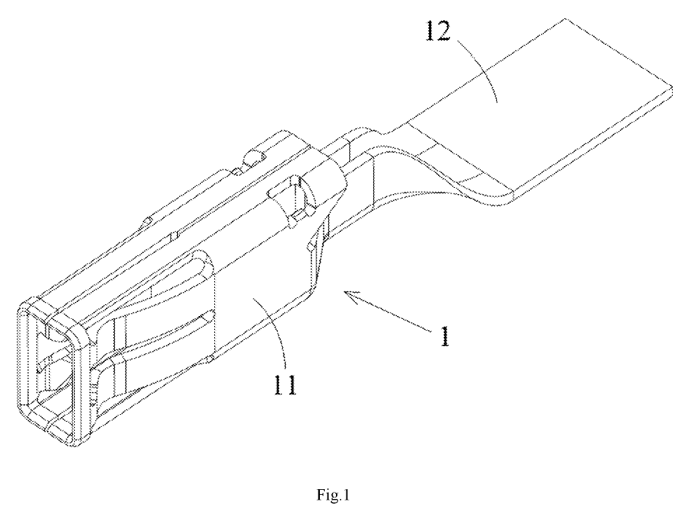

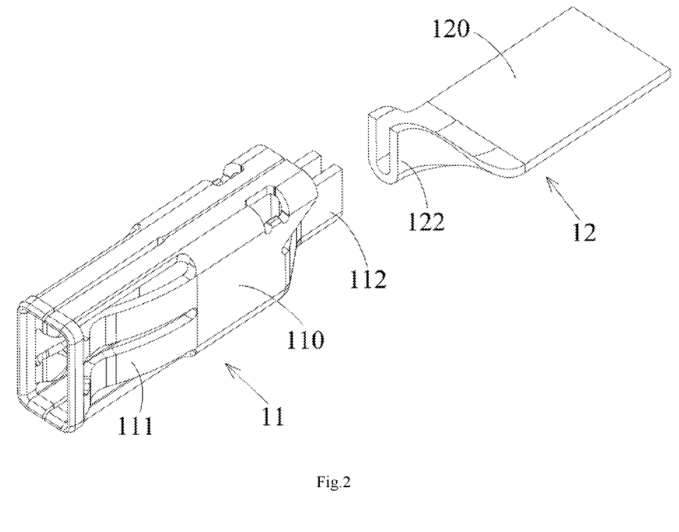

FIGS. 1 and 2 show a first embodiment according to the present invention. Among them, FIG. 1 shows an illustrative perspective view of a terminal according to an exemplary first embodiment of the present invention; FIG. 2 shows an illustrative exploded view of a terminal according to an exemplary first embodiment of the present invention.

As shown in FIGS. 1 and 2, in an exemplary embodiment of the present invention, a terminal 1 is disclosed. The terminal 1 includes an electrical contact part 11 and an electrical connection part 12. The electrical contact part 11 is used to make electrical contact with a mating terminal (not shown). The electrical connection part 12 is used for electrical connection with an aluminum cable (not shown). The electrical contact part 11 and the electrical connection part 12 are connected as a whole. The electrical contact part 11 is made of copper or copper alloy, and the electrical connection part 12 is made of aluminum or aluminum alloy.

As shown in FIGS. 1 and 2, in the illustrated embodiment, the electrical contact part 11 has at least one elastic arm 111 for electrical contact with the mating terminal.

As shown in FIGS. 1 and 2, in the illustrated embodiment, the electrical contact part 11 has at least one pair of elastic arms 111, each pair of elastic arms 111 being used to clamp the mating terminal inserted between them for electrical contact with the mating terminal.

As shown in FIGS. 1 and 2, in the illustrated embodiment, the electrical contact part 11 includes a peripheral wall 110 surrounding an insertion cavity, and an elastic arm 111 is formed on the peripheral wall 110 for electrical contact with a mating terminal inserted into the insertion cavity.

However, the present invention is not limited to the illustrated embodiment. For example, in another exemplary embodiment of the present invention, the terminal 1 may be a male terminal, and the electrical contact part 11 may be cylindrical or tongue shaped and suitable for insertion into a female mating terminal to make electrical contact with a contact spring (not shown) of the mating terminal.

As shown in FIGS. 1 and 2, in the illustrated embodiment, the electrical contact part 11 of the terminal is an integral stamped part. The electrical connection part 12 of the terminal is an integral stamped part. This can improve manufacturing efficiency and reduce production costs.

As shown in FIGS. 1 and 2, in the illustrated embodiment, the electrical connection part 12 of the terminal is adapted to be soldered to the connection end of the aluminum cable.

As shown in FIGS. 1 and 2, in the illustrated embodiment, the electrical connection part 12 of the terminal has a flat welding part 120, which is suitable for being welded to the connection end of the aluminum cable.

As shown in FIGS. 1 and 2, in an exemplary embodiment of the present invention, the electrical contact part 11 can be welded, heat fused, cold-rolled, riveted, crimped, or bolted to the electrical connection part 12 to connect the electrical contact part 11 and the electrical connection part 12 as a whole.

As shown in FIGS. 1 and 2, in the illustrated embodiment, the electrical contact part 11 has a U-shaped rear end 112, and the electrical connection part 12 has a U-shaped front end 122. The U-shaped rear end 112 of the electrical contact part 11 is welded or thermally fused to the U-shaped front end 122 of the electrical connection part 12 to connect the electrical contact part 11 and the electrical connection part 12 as a whole.

As shown in FIGS. 1 and 2, in another exemplary embodiment of the present invention, an electrical connection assembly is also disclosed. The electrical connection assembly includes a terminal 1 and an aluminum cable (not shown). The aluminum cable is electrically connected to the electrical connection part 12 of the terminal.

As shown in FIGS. 1 and 2, in another exemplary embodiment of the present invention, an electrical connection device is also disclosed. The electrical connection device includes an insulation housing (not shown), a terminal 1, and an aluminum cable. The terminal 1 is inserted into the insulation housing. The aluminum cable is electrically connected to the electrical connection part 12 of the terminal and led out from the insulation housing.

As shown in FIGS. 1 and 2, in the illustrated embodiment, the electrical connection device can be a connector, a charging dock, or a charging gun, and the terminal is a power terminal for transmitting charging current.

### Second Illustrative Embodiment

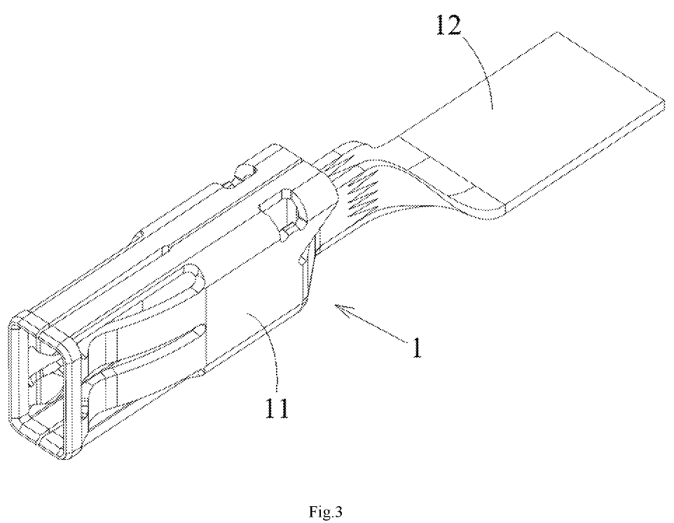

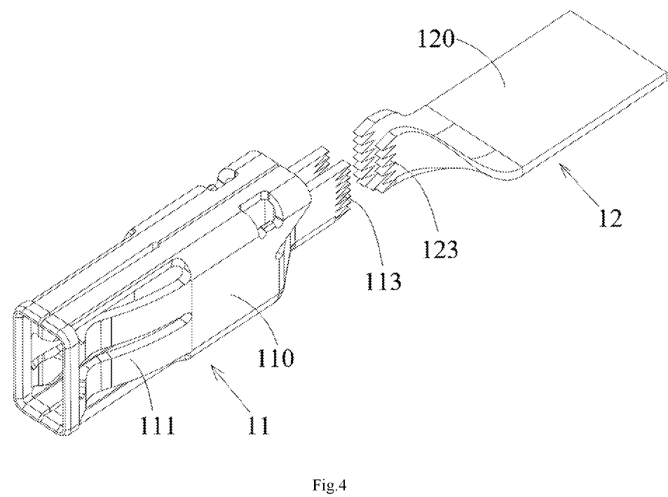

FIGS. 3 and 4 show the first embodiment according to the present invention. Among them, FIG. 3 shows an illustrative perspective view of a terminal according to an exemplary second embodiment of the present invention; FIG. 4 shows an illustrative exploded view of a terminal according to an exemplary second embodiment of the present invention.

As shown in FIGS. 3 and 4, in an exemplary embodiment of the present invention, a terminal 1 is disclosed. The terminal 1 includes an electrical contact part 11 and an electrical connection part 12. The electrical contact part 11 is used to make electrical contact with a mating terminal (not shown). The electrical connection part 12 is used for electrical connection with an aluminum cable (not shown). The electrical contact part 11 and the electrical connection part 12 are connected as a whole. The electrical contact part 11 is made of copper or copper alloy, and the electrical connection part 12 is made of aluminum or aluminum alloy.

As shown in FIGS. 3 and 4, in the illustrated embodiment, the electrical contact part 11 has at least one elastic arm 111 for electrical contact with the mating terminal.

As shown in FIGS. 3 and 4, in the illustrated embodiment, the electrical contact part 11 has at least one pair of elastic arms 111, each pair of elastic arms 111 being used to clamp the mating terminal inserted between them for electrical contact with the mating terminal.

As shown in FIGS. 3 and 4, in the illustrated embodiment, the electrical contact part 11 includes a peripheral wall 110 surrounding an insertion cavity, and an elastic arm 111 is formed on the peripheral wall 110 for electrical contact with the mating terminal inserted into the insertion cavity.

However, the present invention is not limited to the illustrated embodiment. For example, in another exemplary embodiment of the present invention, the terminal 1 may be a male terminal, and the electrical contact part 11 may be cylindrical or tongue shaped and suitable for insertion into a female mating terminal to make electrical contact with a contact spring (not shown) of the mating terminal.

As shown in FIGS. 3 and 4, in the illustrated embodiment, the electrical contact part 11 of the terminal is an integral stamped part. The electrical connection part 12 of the terminal is an integral stamped part. This can improve manufacturing efficiency and reduce production costs.

As shown in FIGS. 3 and 4, in the illustrated embodiment, the electrical connection part 12 of the terminal is adapted to be soldered to the connection end of the aluminum cable.

As shown in FIGS. 3 and 4, in the illustrated embodiment, the electrical connection part 12 of the terminal has a flat welding part 120, which is suitable for being welded to the connection end of the aluminum cable.

As shown in FIGS. 3 and 4, in an exemplary embodiment of the present invention, the electrical contact part 11 can be welded, heat fused, cold-rolled, riveted, crimped, or bolted to the electrical connection part 12 to connect the electrical contact part 11 and the electrical connection part 12 as a whole.

As shown in FIGS. 3 and 4, in the illustrated embodiment, a first saw tooth 113 is formed on the electrical contact part 11, and a second saw tooth 123 is formed on the electrical connection part 12. The first saw tooth 113 meshes with the second saw tooth 123 and they are welded, hot-melt welded, or cold-rolled together to connect the electrical contact part 11 and the electrical connection part 12 as a whole.

As shown in FIGS. 3 and 4, in another exemplary embodiment of the present invention, an electrical connection assembly is also disclosed. The electrical connection assembly includes a terminal 1 and an aluminum cable (not shown). The aluminum cable is electrically connected to the electrical connection part 12 of the terminal.

As shown in FIGS. 3 and 4, in another exemplary embodiment of the present invention, an electrical connection device is also disclosed. The electrical connection device includes an insulation housing (not shown), a terminal 1, and an aluminum cable. The terminal 1 is inserted into the insulation housing. The aluminum cable is electrically connected to the electrical connection part 12 of the terminal and led out from the insulation housing.

As shown in FIGS. 3 and 4, in the illustrated embodiment, the electrical connection device can be a connector, a charging dock, or a charging gun, and the terminal is a power terminal used for transmitting charging current.

### Third Illustrative Embodiment

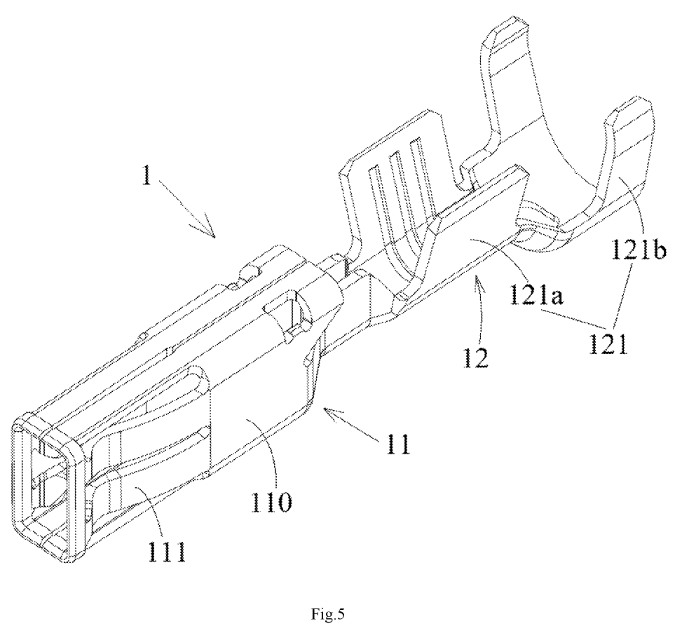

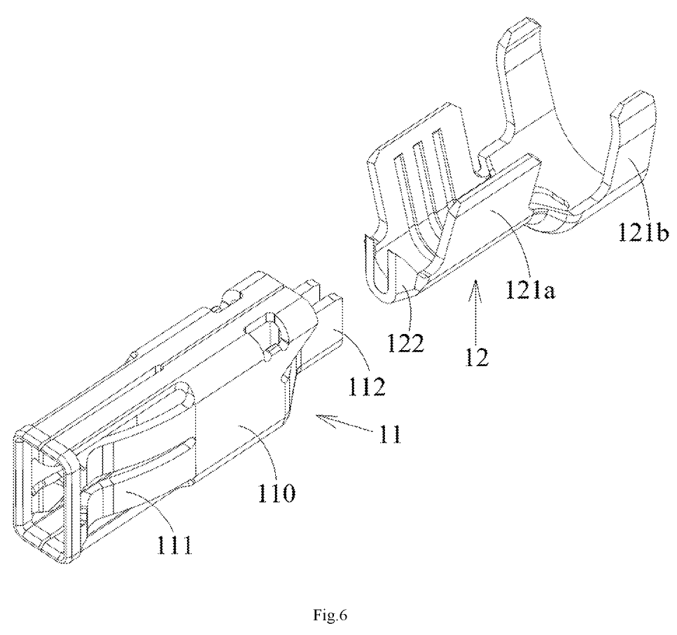

FIGS. 5 and 6 show a third embodiment according to the present invention. Among them, FIG. 5 shows an illustrative perspective view of a terminal according to an exemplary third embodiment of the present invention; FIG. 6 shows an illustrative exploded view of a terminal according to an exemplary third embodiment of the present invention.

As shown in FIGS. 5 and 6, in an exemplary embodiment of the present invention, a terminal 1 is disclosed. The terminal 1 includes an electrical contact part 11 and an electrical connection part 12. The electrical contact part 11 is used to make electrical contact with a mating terminal (not shown). The electrical connection part 12 is used for electrical connection with an aluminum cable (not shown). The electrical contact part 11 and the electrical connection part 12 are connected as a whole. The electrical contact part 11 is made of copper or copper alloy, and the electrical connection part 12 is made of aluminum or aluminum alloy.

As shown in FIGS. 5 and 6, in the illustrated embodiment, the electrical contact part 11 has at least one elastic arm 111 for electrical contact with the mating terminal.

As shown in FIGS. 5 and 6, in the illustrated embodiment, the electrical contact part 11 has at least one pair of elastic arms 111, each pair of elastic arms 111 being used to clamp the mating terminal inserted between them for electrical contact with the mating terminal.

As shown in FIGS. 5 and 6, in the illustrated embodiment, the electrical contact part 11 includes a peripheral wall 110 surrounding an insertion cavity, and an elastic arm 111 is formed on the peripheral wall 110 for electrical contact with the mating terminal inserted into the insertion cavity.

However, the present invention is not limited to the illustrated embodiment. For example, in another exemplary embodiment of the present invention, the terminal 1 may be a male terminal, and the electrical contact part 11 may be cylindrical or tongue shaped and suitable for insertion into a female mating terminal to make electrical contact with a contact spring (not shown) of the mating terminal.

As shown in FIGS. 5 and 6, in the illustrated embodiment, the electrical contact part 11 of the terminal is an integral stamped part. The electrical connection part 12 of the terminal is an integral stamped part. This can improve manufacturing efficiency and reduce production costs.

As shown in FIGS. 5 and 6, in the illustrated embodiment, the electrical connection part 12 of the terminal is adapted to be crimped onto the connection end of the aluminum cable.

As shown in FIGS. 5 and 6, in the illustrated embodiment, the electrical connection part 12 of the terminal has a U-shaped crimping part 121, which is suitable for crimping to the connection end of the aluminum cable.

As shown in FIGS. 5 and 6, in the illustrated embodiment, the U-shaped crimping part 121 includes a pair of first crimping wings 121a, which are used to crimp to the connection end of the aluminum cable.

As shown in FIGS. 5 and 6, in the illustrated embodiment, the U-shaped crimping part 121 further includes a pair of second crimping wings 121b, which are used to crimp onto the outer insulation layer of the aluminum cable.

As shown in FIGS. 5 and 6, in an exemplary embodiment of the present invention, the electrical contact part 11 can be welded, heat fused, cold-rolled, riveted, crimped, or bolted to the electrical connection part 12 to connect the electrical contact part 11 and the electrical connection part 12 as a whole.

As shown in FIGS. 5 and 6, in the illustrated embodiment, the electrical contact part 11 has a U-shaped rear end 112, and the electrical connection part 12 has a U-shaped front end 122. The U-shaped rear end 112 of the electrical contact part 11 is welded or thermally fused to the U-shaped front end 122 of the electrical connection part 12 to connect the electrical contact part 11 and the electrical connection part 12 as a whole.

As shown in FIGS. 5 and 6, in another exemplary embodiment of the present invention, an electrical connection assembly is also disclosed. The electrical connection assembly includes a terminal 1 and an aluminum cable (not shown). The aluminum cable is electrically connected to the electrical connection part 12 of the terminal.

As shown in FIGS. 5 and 6, in another exemplary embodiment of the present invention, an electrical connection device is also disclosed. The electrical connection device includes an insulation housing (not shown), a terminal 1, and an aluminum cable. The terminal 1 is inserted into the insulation housing. The aluminum cable is electrically connected to the electrical connection part 12 of the terminal and led out from the insulation housing.

As shown in FIGS. 5 and 6, in the illustrated embodiment, the electrical connection device can be a connector, a charging dock, or a charging gun, and the terminal is a power terminal for transmitting charging current.

### Fourth Illustrative Embodiment

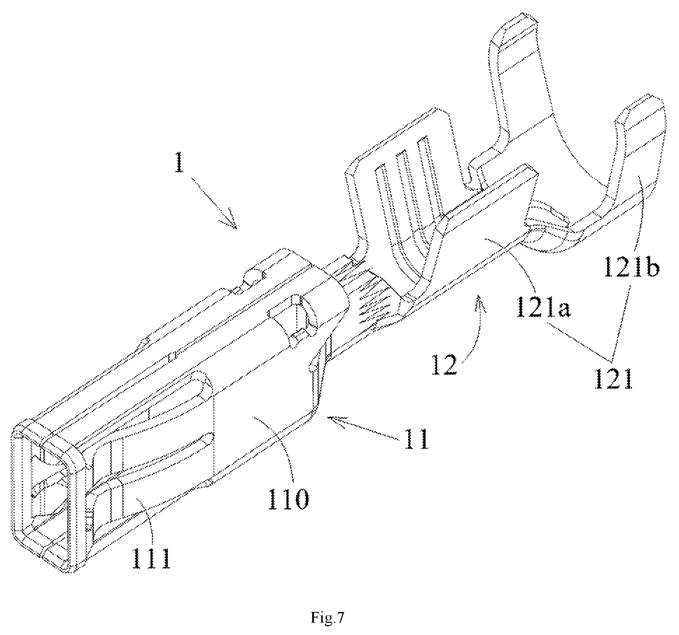

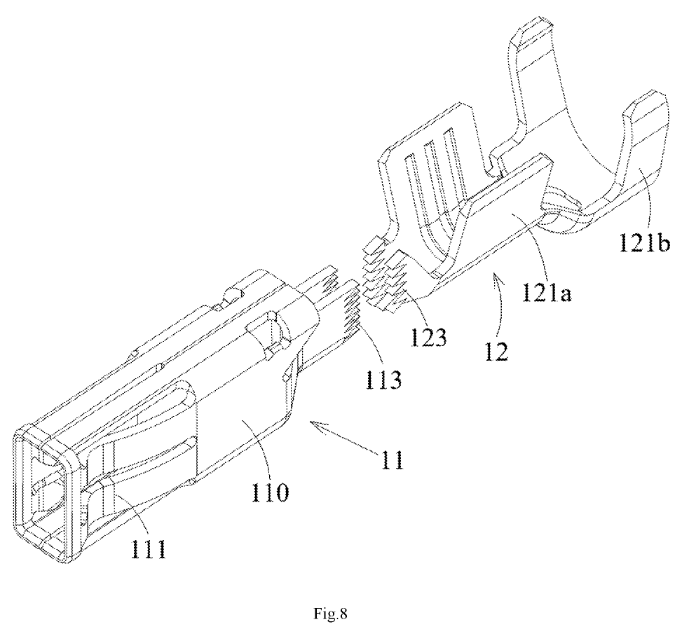

FIGS. 7 and 8 show a fourth embodiment according to the present invention. Among them, FIG. 7 shows an illustrative perspective view of a terminal according to an exemplary fourth embodiment of the present invention; FIG. 8 shows an illustrative exploded view of a terminal according to an exemplary fourth embodiment of the present invention.

As shown in FIGS. 7 and 8, in an exemplary embodiment of the present invention, a terminal 1 is disclosed. The terminal 1 includes an electrical contact part 11 and an electrical connection part 12. The electrical contact part 11 is used to make electrical contact with a mating terminal (not shown). The electrical connection part 12 is used for electrical connection with an aluminum cable (not shown). The electrical contact part 11 and the electrical connection part 12 are connected as a whole. The electrical contact part 11 is made of copper or copper alloy, and the electrical connection part 12 is made of aluminum or aluminum alloy.

As shown in FIGS. 7 and 8, in the illustrated embodiment, the electrical contact part 11 has at least one elastic arm 111 for electrical contact with the mating terminal.

As shown in FIGS. 7 and 8, in the illustrated embodiment, the electrical contact part 11 has at least one pair of elastic arms 111, each pair of elastic arms 111 being used to clamp the mating terminal inserted between them for electrical contact with the mating terminal.

As shown in FIGS. 7 and 8, in the illustrated embodiment, the electrical contact part 11 includes a peripheral wall 110 surrounding an insertion cavity, and an elastic arm 111 is formed on the peripheral wall 110 for electrical contact with the mating terminal inserted into the insertion cavity.

However, the present invention is not limited to the illustrated embodiment. For example, in another exemplary embodiment of the present invention, terminal 1 may be a male terminal, and the electrical contact part 11 may be cylindrical or tongue shaped and suitable for insertion into a female mating terminal to make electrical contact with a contact spring (not shown) of the mating terminal.

As shown in FIGS. 7 and 8, in the illustrated embodiment, the electrical contact part 11 of the terminal is an integral stamped part. The electrical connection part 12 of the terminal is an integra stamped part. This can improve manufacturing efficiency and reduce production costs.

As shown in FIGS. 7 and 8, in the illustrated embodiment, the electrical connection part 12 of the terminal is adapted to be crimped onto the connection end of the aluminum cable.

As shown in FIGS. 7 and 8, in the illustrated embodiment, the electrical connection part 12 of the terminal has a U-shaped crimping part 121, which is suitable for crimping to the connection end of the aluminum cable.

As shown in FIGS. 7 and 8, in the illustrated embodiment, the U-shaped crimping part 121 includes a pair of first crimping wings 121a, which are used to crimp to the connection end of the aluminum cable.

As shown in FIGS. 7 and 8, in the illustrated embodiment, the U-shaped crimping part 121 further includes a pair of second crimping wings 121b, which are used to crimp onto the outer insulation layer of the aluminum cable.

As shown in FIGS. 7 and 8, in an exemplary embodiment of the present invention, the electrical contact part 11 can be welded, heat fused, cold-rolled, riveted, crimped, or bolted to the electrical connection part 12 to connect the electrical contact part 11 and the electrical connection part 12 as a whole.

As shown in FIGS. 7 and 8, in the illustrated embodiment, a first saw tooth 113 is formed on the electrical contact part 11, and a second saw tooth 123 is formed on the electrical connection part 12. The first saw tooth 113 meshes with the second saw tooth 123 and they are welded, hot-melt welded, or cold-rolled together to connect the electrical contact part 11 and the electrical connection part 12 as a whole.

As shown in FIGS. 7 and 8, in another exemplary embodiment of the present invention, an electrical connection assembly is also disclosed. The electrical connection assembly includes a terminal 1 and an aluminum cable (not shown). The aluminum cable is electrically connected to the electrical connection part 12 of the terminal.

As shown in FIGS. 7 and 8, in another exemplary embodiment of the present invention, an electrical connection device is also disclosed. The electrical connection device includes an insulation housing (not shown), a terminal 1, and an aluminum cable. The terminal 1 is inserted into the insulation housing. The aluminum cable is electrically connected to the electrical connection part 12 of the terminal and led out from the insulation housing.

As shown in FIGS. 7 and 8, in the illustrated embodiment, the electrical connection device can be a connector, a charging dock, or a charging gun, and the terminal is a power terminal for transmitting charging current.

However, the present invention is not limited to the illustrated embodiments. For example, the electrical connection part 12 of terminal 1 can also be thermally fused, riveted, or bolted to the connection end of the aluminum cable.

### Example of Illustrative Terminal Manufacturing Method

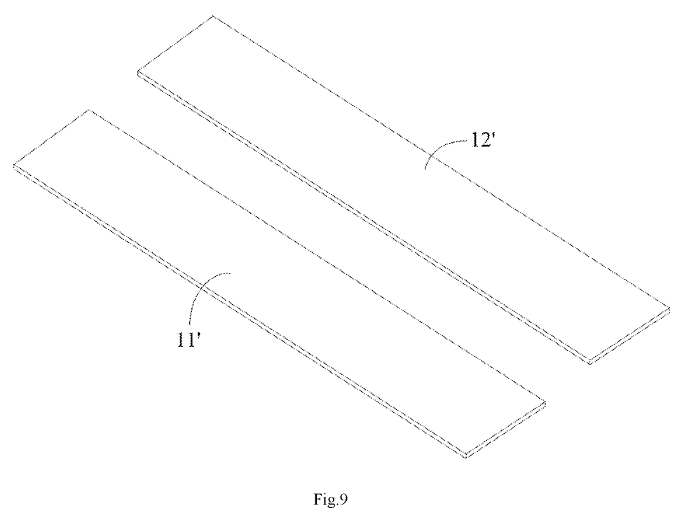

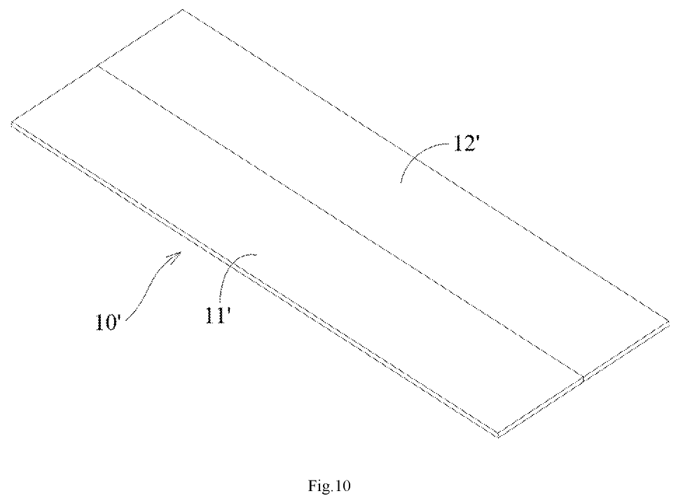

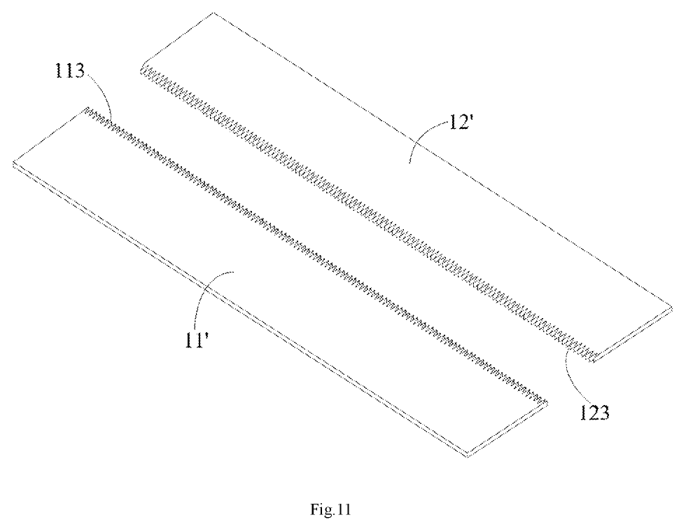

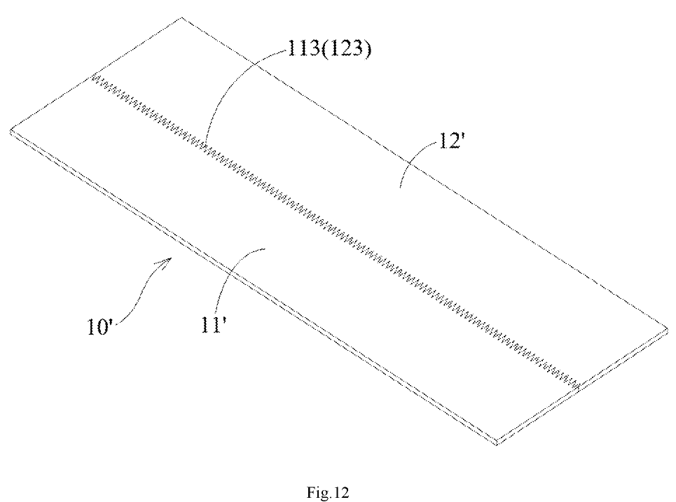

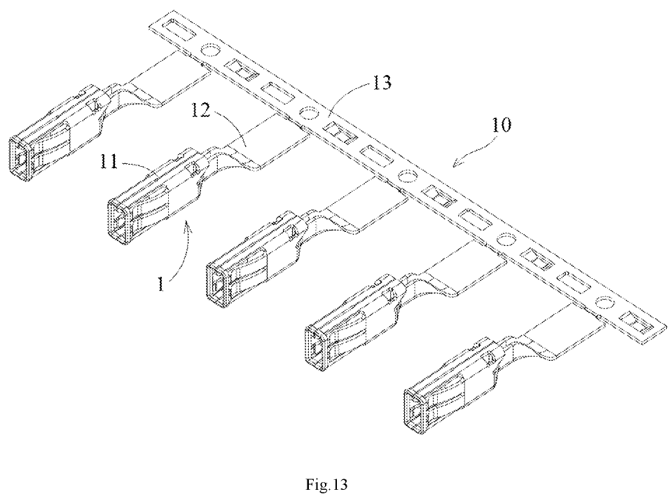

FIGS. 9-14 show the manufacturing method of the terminals shown in FIGS. 1-8. Among them, FIG. 9 shows an illustrative perspective view of an exemplary first metal plate 11’and second metal plate 12’ according to the present invention; FIG. 10 shows an illustrative view of connecting the first metal plate 11’and the second metal plate 12’ shown in FIG. 9 together; FIG. 11 shows an illustrative perspective view of another exemplary first metal plate 11’and second metal plate 12’ according to the present invention; FIG. 12 shows an illustrative view of connecting the first metal plate 11’and the second metal plate 12’ shown in FIG. 11 together; FIG. 13 shows an illustrative view of a terminal strip 10 made by stamping the metal sheet 10’shown in FIGS. 10 or 12; 14 shows another illustrative view of a terminal strip 10 made by stamping the metal sheet 10’shown in FIGS. 10 or 12.

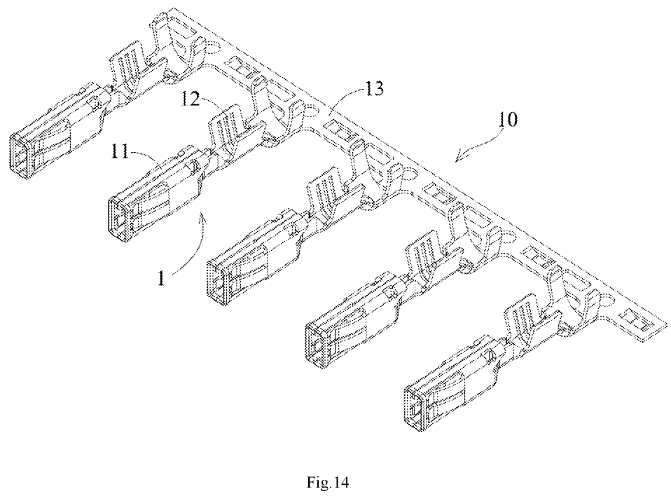

As shown in FIGS. 9-14, in an exemplary embodiment of the present invention, a terminal manufacturing method is also disclosed. The terminal manufacturing method includes the following steps of:
S10: Refer to FIGS. 9 and 11, providing a first metal plate 11’and a second metal plate 12’;
S20: Refer to FIGS. 10 and 12, connecting one side of the first metal plate 11’ and one side of the second metal plate 12’ together to form a metal sheet 10’;
S30: Refer to FIGS. 13 and 14, punching the metal sheet 10’ to form a terminal strip 10; and
S40: Refer to FIGS. 13 and 14, cutting the terminal strip 10 to obtain multiple terminals 1,

As shown in FIGS. 9-14, in the illustrated embodiment, the first metal plate 11’ is a copper plate or copper alloy plate, the electrical contact part 11 of terminal 1 for electrical contact with the mating terminal is made of the first metal plate 11’, the second metal plate 12’ is an aluminum plate, and the electrical connection part 12 of terminal 1 for electrical connection with an aluminum cable is made of the second metal plate 12’.

As shown in FIGS. 9-14, in the illustrated embodiment, the terminal strip 10 has a carrier part 13 for positioning and transporting the terminal 1, which is connected to the electrical connection part 12 of the terminal 1. The carrier part 13 is made of a second metal plate 12’.

As shown in FIGS. 9-14, in the illustrated embodiment, one side of the first metal plate 11’ and one side of the second metal plate 12’ are welded, hot-melt welded, or cold-rolled together.

As shown in FIGS. 9-14, in the illustrated embodiment, a first saw tooth 113 is formed on one side of the first metal plate 11’, and a second saw tooth 123 is formed on one side of the second metal plate 12’. The first saw tooth 113 meshes with the second saw tooth 123 and they are welded, hot-melt welded, or cold-rolled together. This can improve the bonding strength between the first metal plate 11’ and the second metal plate 12’.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word "a" or "an" should be understood as not excluding plural of said elements or steps, unless such exclusion is explicitly stated. Furthermore, references to "one embodiment" of the present invention are not intended to be interpreted as excluding the existence of additional embodiments that also incorporate the recited features. Moreover, unless explicitly stated to the contrary, embodiments "comprising" or "having" an element or a plurality of elements having a particular property may include additional such elements not having that property.

What is claimed is:

1. A terminal, comprising:
an electrical contact part which is used to make electrical contact with a mating terminal; and
an electrical connection part which is used for electrical connection with an aluminum cable,
wherein the electrical contact part and the electrical connection part are connected as a whole, the electrical contact part is a copper component or a copper alloy component, and the electrical connection part is an aluminum component or an aluminum alloy component.

2. The terminal according to claim 1,
wherein the electrical contact part has at least one elastic arm for electrical contact with the mating terminal.

3. The terminal according to claim 1,
wherein the electrical contact part has at least one pair of elastic arms, each pair of elastic arms is used to clamp the mating terminal inserted between them for electrical contact with the mating terminal.

4. The terminal according to claim 1,
wherein the electrical contact part comprises a peripheral wall enclosing an insertion cavity, and an elastic arm is formed on the peripheral wall for electrical contact with a mating terminal inserted into the insertion cavity.

5. The terminal according to claim 1,
wherein the electrical contact part is cylindrical or tongue shaped and suitable for insertion into a female mating terminal to make electrical contact with the contact spring of the mating terminal.

6. The terminal according to claim 1,
wherein the electrical contact part of the terminal is an integral stamped part; and/or
wherein the electrical connection part of the terminal is an integral stamped part.

7. The terminal according to claim 1,
wherein the electrical connection part of the terminal is suitable for being welded to the connection end of the aluminum cable.

8. The terminal according to claim 7,
wherein the electrical connection part of the terminal has a flat welding part, which is suitable for being welded to the connection end of the aluminum cable.

9. The terminal according to claim 1,
wherein the electrical connection part of the terminal is suitable for being crimped onto the connection end of the aluminum cable.

10. The terminal according to claim 9,
wherein the electrical connection part of the terminal has a U-shaped crimping part, which is suitable for being crimped onto the connection end of the aluminum cable.

11. The terminal according to claim 10,
wherein the U-shaped crimping part comprises a pair of first crimping wings for crimping onto the connection end of the aluminum cable.

12. The terminal according to claim 11,
wherein the U-shaped crimping part further comprises a pair of second crimping wings for crimping onto the outer insulation layer of the aluminum cable.

13. The terminal according to claim 1,
wherein the electrical connection part of the terminal is suitable for being welded, crimped, hot-melt, riveted or bolted to the connection end of the aluminum cable.

14. The terminal according to claim 1,
wherein the electrical contact part is welded, hot melted, cold-rolled, riveted, crimped or bolted to the electrical connection part to connect the electrical contact part and the electrical connection part as a whole.

15. The terminal according to claim 1,
wherein the electrical contact part has a U-shaped rear end, and the electrical connection part has a U-shaped front end; the U-shaped rear end of the electrical contact part is welded or thermally fused to the U-shaped front end of the electrical connection part to connect the electrical contact part and the electrical connection part as a whole.

16. The terminal according to claim 1,
wherein a first saw tooth is formed on the electrical contact part, and a second saw tooth is formed on the electrical connection part; the first saw tooth meshes with the second saw tooth and they are welded, hot-melt welded, or cold-rolled together to connect the electrical contact part and the electrical connection part as a whole.

17. An electrical connection assembly, comprising:
the terminal according to claim 1; and
an aluminum cable which is electrically connected to the electrical connection part of the terminal.

18. An electrical connection device, comprising:
an insulation housing;
the terminal according to claim 1, which is inserted into the insulation housing; and
an aluminum cable which is electrically connected to the electrical connection part of the terminal and led out from the insulation housing.

19. The electrical connection device according to claim 18,
wherein the electrical connection device is a connector, a charging dock, or a charging gun, and the terminal is a power terminal used for transmitting charging current.

20. A terminal manufacturing method, comprising the following steps of:
providing a first metal plate and a second metal plate;
connecting one side of the first metal plate and one side of the second metal plate together to form a metal sheet;
stamping the metal sheet to form a terminal strip; and
cutting the terminal strip to obtain multiple terminals,
wherein the first metal plate is a copper plate or a copper alloy plate, and an electrical contact part of the terminal for electrical contact with a mating terminal is made of the first metal plate,
wherein the second metal plate is an aluminum plate, and an electrical connection part of the terminal for electrical connection with an aluminum cable is made of the second metal plate.

21. The terminal manufacturing method according to claim 20,
wherein the terminal strip has a carrier part connected to the electrical connection part of the terminal for positioning and conveying the terminal, and the carrier part is made of the second metal plate.

22. The terminal manufacturing method according to claim 20,
wherein one side of the first metal plate and one side of the second metal plate are welded, hot-melt or cold-rolled together.

23. The terminal manufacturing method according to claim 20,
wherein a first saw tooth is formed on one side of the first metal plate, and a second saw tooth is formed on one side of the second metal plate; the first saw tooth meshes with the second saw tooth and they are welded, hot-melt welded, or cold-rolled together.
